(19) United States
(12) Patent Application Publication
(10) Pub. No.: US 2008/0267775 A1
(43) Pub. Date: Oct. 30, 2008

(54) Nozzle segments and method of repairing the same

(75) Inventors: Wayne Ray Grady, Hamilton, OH (US); Luciana de Fatima Lira Dederichs, Rio de Janerio (BR); Sidmar Mauricio de Mello, Rio de Janerio (BR); Warren Davis Grossklaus, West Chester, OH (US); Alistair Jeffrey Smith, Simpsonville, SC (US); Toby Lee Norman, Slippery Rock, PA (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/799,299

(22) Filed: Apr. 30, 2007

(51) Int. Cl. F01D 9/06; B23P 6/04

(52) U.S. Cl. 415/208.1; 29/889.1; 29/888.021

(57) ABSTRACT

A method of repairing a nozzle segment is provided. The nozzle segment includes at least one airfoil extending between an inner band and an outer band, and the airfoil includes a first sidewall and an opposing second sidewall that are joined together at a leading edge and at an axially-spaced trailing edge. The method includes identifying a damaged portion of the airfoil, repairing the damaged portion of the airfoil by at least one of welding weld filler in the area of the damaged portion of the airfoil, and brazing preform in the area of the damaged portion of the airfoil, and blending at least one of the weld filler and the preform to remove excess material to facilitate finishing an outer surface of the airfoil.

### BACKGROUND OF THE INVENTION

This invention relates generally to diesel motor turbo chargers and to gas turbine engines, and more specifically to nozzle segments used with diesel motor turbo chargers and gas turbine engines.

At least some known engines include a turbine and/or a turbocharger that includes a turbine nozzle assembly. At least some known nozzle assemblies include at least one airfoil that extends generally radially between an inner band and an outer band. Each airfoil includes a pressure side and a suction side that are connected together at leading and trailing edges.

During operation, the leading and trailing edges of the nozzle assembly airfoils may deteriorate or become damaged due to any of a number of distress modes, including, but not limited to, foreign object damage (FOD), tip rubbing, oxidation, thermal fatigue cracking, or erosion caused by abrasives and/or corrosives in the gas stream. To facilitate reducing adverse effects that may be generated as a result of operating nozzle assemblies, and more particularly to airfoils, the airfoils are periodically inspected for damage to determine an amount of damage and/or deterioration. If inspection reveals that any of the airfoils have lost a substantial quantity of material along their leading and/or trailing edges, in particular, the nozzle assembly is replaced. In contrast, if the inspection does not reveal any airfoils are damaged or deteriorated beyond a pre-defined limit, the nozzle assembly may remain in service.

### BRIEF DESCRIPTION OF THE INVENTION

In one aspect, a method of repairing a nozzle segment is provided. The nozzle segment includes at least one airfoil extending between an inner band and an outer band, and the airfoil includes a first sidewall and an opposing second sidewall that are joined together at a leading edge and at an axially-spaced trailing edge. The method includes identifying a damaged portion of the airfoil, repairing the damaged portion of the airfoil by at least one of welding weld filler in the area of the damaged portion of the airfoil at room temperature, and brazing preform in the area of the damaged portion of the airfoil, and blending at least one of the weld filler and the preform to remove excess material to facilitate finishing an outer surface of the airfoil.

In another aspect, a method of repairing a turbine nozzle segment for use in a gas turbine engine. The nozzle segment includes at least one airfoil extending between an inner band and an outer band. The airfoil includes a first sidewall and an opposing second sidewall that are joined together at a leading edge and at an axially-spaced trailing edge. The method includes identifying a damaged portion of the airfoil, repairing the damaged portion of the airfoil by at least one of welding weld filler in the area of the damaged portion of the airfoil to repair the airfoil at an elevated temperature, and brazing preform in the area of the damaged portion of the airfoil, and blending at least one of weld filler and preform to remove excess material to facilitate finishing an outer surface of the airfoil.

In a further aspect, a turbine nozzle segment is provided. The nozzle segment includes at least one airfoil extending between an inner band and an outer band. The airfoil includes a first sidewall and an opposing second sidewall that are joined together at a leading edge and at an axially-spaced trailing edge, a damaged portion positioned along at least one of the leading edge, trailing edge, first sidewall, and second sidewall, and at least one of a weld repair and a preform braze coupled to the at least one airfoil in the area of the damaged portion.

### BRIEF DESCRIPTION OF THE DRAWINGS

FIG. 1 is a perspective view of an exemplary turbine nozzle including two airfoils;

FIG. 2 is a perspective view of an exemplary turbine nozzle assembly including a damaged airfoil having linear damage;

FIG. 3 is an enlarged perspective view of the damaged airfoil shown in FIG. 2 and repaired using the repair methods described herein;

FIG. 4 is a perspective view of the turbine nozzle assembly shown in FIG. 2 and including a damaged airfoil having non-linear damage; and

FIG. 5 is an enlarged perspective view of the damaged airfoil shown in FIG. 4 and repaired using the repair methods described herein.

### DETAILED DESCRIPTION OF THE INVENTION

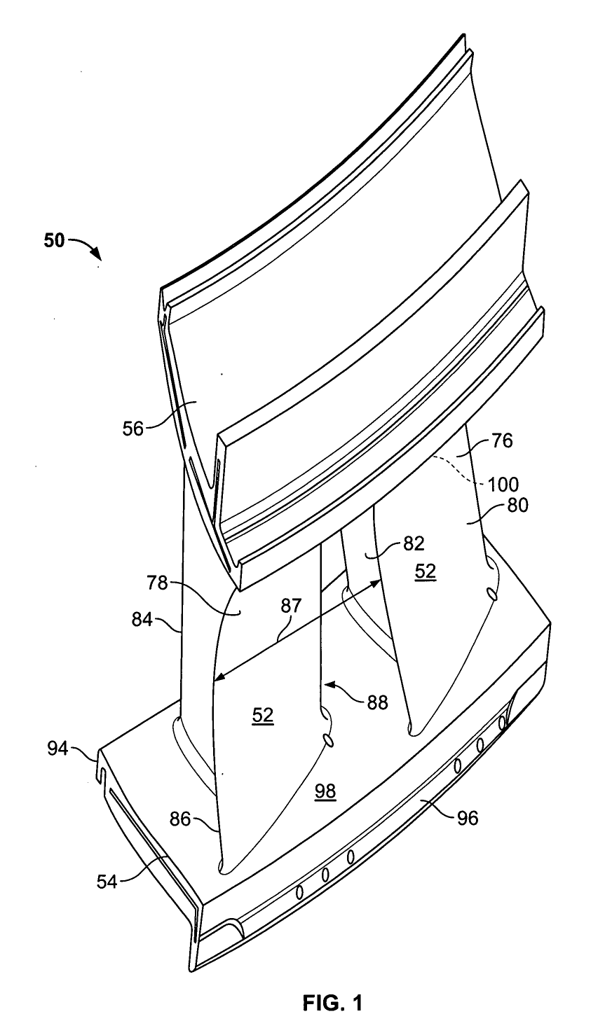

FIG. 1 is a perspective view of an exemplary turbine nozzle segment 50 that may be used with a turbine engine. In the exemplary embodiment, the engine is one of, but is not limited to, being a gas turbine engine or a diesel motor turbo charger. In one embodiment, the gas turbine engine is a CFM56-3 available from General Electric Company, Cincinnati, Ohio. In the exemplary embodiment, turbine nozzle segment 50 includes two airfoils 52 and is generally known as a doublet. During engine assembly, a plurality of turbine nozzle segments 50 are circumferentially coupled together to form a nozzle ring or a turbine nozzle assembly (not shown in FIG. 1).

In the exemplary embodiment, turbine nozzle segment 50 includes two circumferentially-spaced airfoils 52 coupled together by an arcuate radially outer band or platform 54, and an arcuate radially inner band or platform 56. More specifically, in the exemplary embodiment, each band 54 and 56 is integrally-formed with airfoil 52. In an alternative embodiment, turbine nozzle 50 includes only a single airfoil 52 known as a singlet. In another alternative embodiment, turbine nozzle 50 includes more than two airfoils 52.

In the exemplary embodiment, airfoils 52 are substantially identical and each airfoil 52 includes a leading airfoil 76 and a trailing airfoil 78. Each airfoil 52 includes a first sidewall 80 and a second sidewall 82. In the exemplary embodiment, first sidewall 80 is convex and defines a suction side of airfoil 52, and second sidewall 82 is concave and defines a pressure side of airfoil 52. Sidewalls 80 and 82 are joined together at a leading edge 84 and at an axially-spaced trailing edge 86 of each airfoil 52. Accordingly, each airfoil trailing edge 86 is spaced chordwise and downstream from each respective airfoil leading edge 84. First and second sidewalls 80 and 82, respectively, each extend longitudinally, or radially outwardly, in span from radially inner band 56 to radially outer band 54. Airfoils 52 are separated by a circumferential distance 87 with respect to trailing edges 86 such that a throat area 88 is defined between airfoils 52.

Outer band 54 includes a radially inner surface 98 an opposite radially outer surface. Similarly, inner band 56 includes a radially inner surface 100 and an opposite radially outer surface. Inner surfaces 98 and 100 define a flow path for combustion gases to flow through each airfoil 52 downstream towards a turbine, for example.

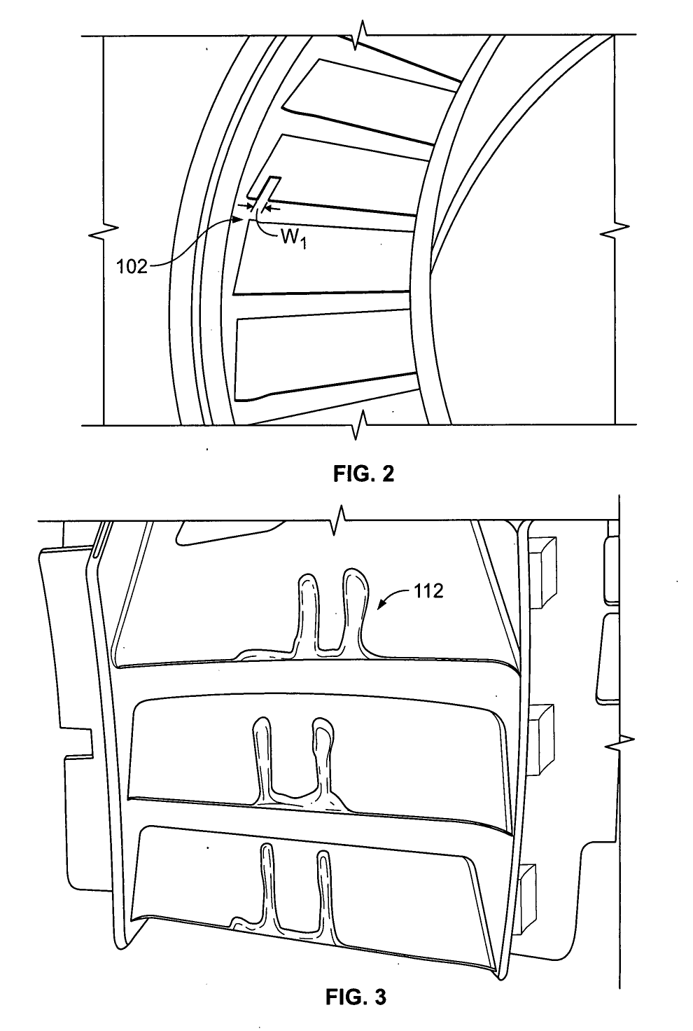

FIG. 2 is a perspective view of an exemplary turbine nozzle assembly including a damaged airfoil having linear damage, and FIG. 3 is an enlarged perspective view of the damaged airfoil and repaired using the repair methods described herein.

During engine operations, turbine nozzle 50 may experience deterioration and/or damage resulting from foreign objects impacting airfoils 52. Such impact may cause portions of airfoils 52 to deteriorate and/or become otherwise damaged in a condition known generally as foreign object damage (FOD).

In the exemplary embodiment, as shown in FIG. 2, airfoil 52 includes a damaged portion 102 that has formed along trailing edge 86. More specifically, in the exemplary embodiment, damaged portion 102 is linear damage. As used herein, the linear damage refers to damage that has occurred in a substantially straight line across a portion of airfoil 52. Moreover, linear damage may occur along any axis of airfoil 52. In an alternative embodiment, damaged portion 102 is formed along a portion of airfoil 52 including, but not limited to, first sidewall 80, second sidewall 82, and/or leading edge 84.

After damaged portion 102 has been identified, airfoil 52 is cleaned using at least one of, but not limited to, a liquid cleaning process or a furnace process to remove surface oxidation that may have accumulated on airfoil 52. After cleaning airfoil 52, the overall dimensions of damaged portion 102 are determined. Specifically, a width W₁ of damaged portion 102 is measured. If the width W₁ is less than a predetermined value, then the damaged portion 102 of airfoil 52 may be repaired using methods described herein. For example, the predetermined value may have a range of about 0.01″-0.012″. Moreover, the predetermined value may be determined by taking twice the thickness of a weld wire. For example, if the weld wire has a thickness of 0.06″, the predetermined value would be 0.012″. Specifically, in the exemplary embodiment, to repair airfoil 52, the method of repair includes welding weld filler 110 in the area of damaged portion 102.

In the exemplary embodiment, weld filler 110 is fabricated from substantially the same material as that used in fabricating airfoil 52. More specifically, in the exemplary embodiment, weld filler 110 is a nickel-based weld filler. In an alternative embodiment, weld filler 110 is fabricated from any material that enables weld filler 110 to repair damaged portions 102 of airfoil 52, such as, but not limited to, tungsten.

In the exemplary embodiment, weld filler 110 is welded to airfoil 52 using at least one of, but not limited to, plasma arc welding, tungsten inert gas welding, and metal inert gas welding. More specifically, airfoil 52 is welded at room temperature such that a weld bead 112 is formed along airfoil 52 in the area of damaged portion 102. In an alternative embodiment, any suitable method of welding may be used to weld the weld filler 110 to airfoil 52.

In an alternative embodiment, weld filler 110 is welded in the area of damaged portion 102 at a temperature that is higher than room temperature. Specifically, in such an embodiment, weld filler 110 is welded to airfoil 52 using a superalloy weld at elevated temperatures (SWET) welding. When SWET welding, the elevated temperature is greater than 1400° and a gamma-prime precipitation strengthened nickel based superalloy is used. In such an embodiment, when SWET welding, weld filler 110 may be either R′77 weld wire or R′41 weld wire, or any other weld wire that facilitates repair of airfoil 52.

Once welding is complete, weld bead 112 and airfoil 52 are polished or finished using any suitable polishing process that facilitates the removal of excess material. Specifically, the airfoil 52 is polished to form a repaired airfoil having desired finish dimensions. Welding filler 110 is also machined to blend airfoil 52 to a contour that substantially mirrors the contour of airfoil 52 when newly manufactured.

In the exemplary embodiment, after weld bead 112 and airfoil 52 have been polished, an environmental protection coating (not shown) is applied to at least a portion of airfoil 52. The protective coating may be any suitable coating that facilitates preventing surface oxidation of airfoil 52. Once the protective coating has been applied, the final dimensions of the airfoil are determined and compared to pre-defined finished dimensions. If throat area 88 has not been maintained or does not meet predefined specifications, trailing edges 86 of airfoils 52 may be adjusted.

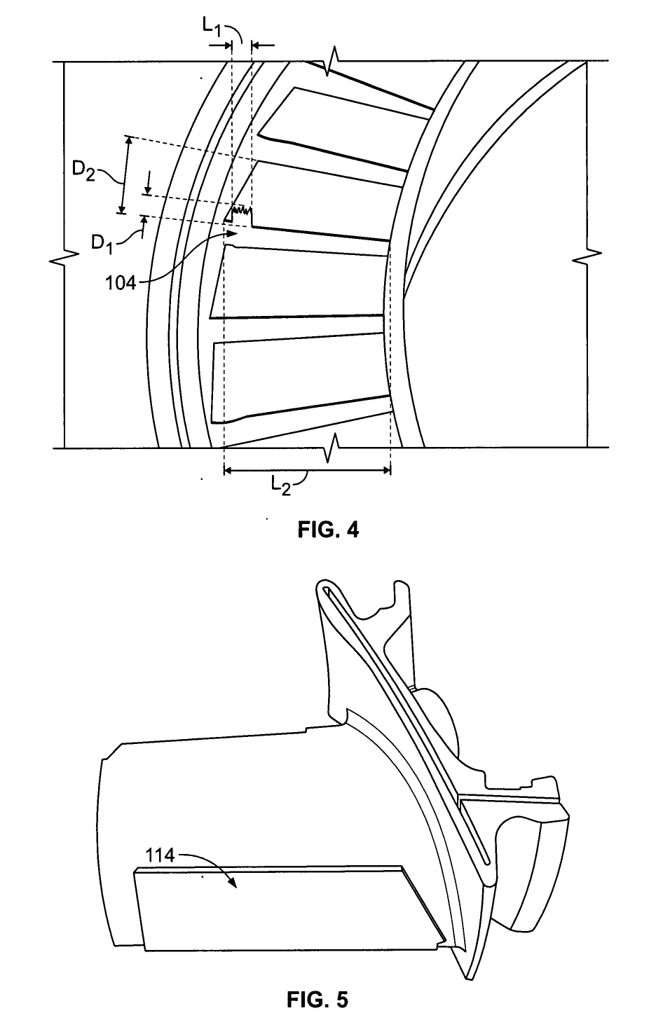

FIG. 4 is a perspective view of the turbine nozzle assembly and including a damaged airfoil having non-linear damage, and FIG. 5 is an enlarged perspective view of the damaged airfoil and repaired using the repair methods described herein.

In addition, as shown in FIG. 4, airfoil 52 includes a damaged portion 104 that has formed along trailing edge 86. More specifically, in the exemplary embodiment, damaged portion 104 is non-linear missing material damage. As used herein, the nonlinear missing material damage refers to damage that has not occurred in a substantially straight line across a portion of airfoil 52. In an alternative embodiment, damaged portion 104 is formed along a portion of airfoil 52 including, but not limited to, first sidewall 80, second sidewall 82, and/or leading edge 84.

After damaged portion 104 has been identified, airfoil 52 is cleaned using at least one of, but not limited to, a liquid cleaning process or a furnace process to remove surface oxidation that may have accumulated on airfoil 52. After cleaning airfoil 52, the overall dimensions of damaged portion 104 are determined. Specifically, an axial length L₁ and a depth D₁ of damaged portion 104 is measured. If the length L₁ is less than approximately 20% of the total length L₂ of airfoil 52 and the depth D₁ is less than approximately 20% of the total depth D₂ of airfoil 52, then the damaged portion 104 of airfoil 52 may be repaired using methods described herein. Specifically, in the exemplary embodiment, to repair airfoil 52, the method of repair includes brazing a preform 114 in the area of damaged portion 104.

In the exemplary embodiment, preform 114 is fabricated from substantially the same material as that used in fabricating airfoil 52 to facilitate repairing damaged portion 104 of airfoil 52. Specifically, in the exemplary embodiment, preform 114 is fabricated in a predetermined shape from a nickel-based braze filler powder without the use of a Fluoride Ion Cleaning. In an alternative embodiment, preform 114 is fabricated from any material that enables preform 114 to repair damaged portions 104 of airfoil 52.

Preform 114 is positioned to airfoil 52 using resistance welding such as, but not limited to, TIC welding and/or TAC welding. Specifically, airfoil 52 and preform 114 are placed in an oven at a temperature that is higher than room temperature. In the exemplary embodiment, the oven temperature is between approximately 1900-2000°. In the exemplary embodiment, preform 114 is heated, softens, and fuses into damaged portion 104 within the oven. Preform 114, when melted, takes the shape of damaged portion 104 and fills damaged portion 104.

After preform 114 fills damaged portion 104, preform 114 and airfoil 52 are cooled. After cooling airfoil 52, preform 114 and airfoil 52 are polished or finished using any suitable polishing process that facilitates the removal of excess material. Specifically, airfoil 52 is polished to form a repaired airfoil having desired finished dimensions. Preform 114 is also machined to blend airfoil 52 to a contour that substantially mirrors the contour of airfoil 52.

In the exemplary embodiment, after preform 114 and airfoil 52 have been polished, an environmental protection coating (not shown) is applied to at least a portion of airfoil 52. The protective coating may be any suitable coating that facilitates preventing surface oxidation of airfoil 52. Once the protective coating has been applied, the final dimensions of the airfoil are determined and compared to pre-defined finished dimensions. If throat area 88 has not been maintained or does not meet predefined specifications, trailing edges 86 of airfoils 52 may be adjusted.

Described herein is a method of repairing a nozzle assembly that may be utilized on a wide variety of turbofan engine assemblies and locomotive engine assemblies. The method of repairing the nozzle assembly described herein allows repair of nozzle segments with damaged portions and in turn, prevents replacement of various nozzle assemblies. As such, the expense incurred by replacing and fabricating new nozzle assemblies is eliminated. Moreover, the method of repair described herein provides an opportunity to repair damaged trailing edges of airfoils within nozzle assemblies.

An exemplary embodiment of a nozzle assembly is described above in detail. The nozzle assembly illustrated is not limited to the specific embodiments described herein, but rather, components of each assembly may be utilized independently and separately from other components described herein.

While the invention has been described in terms of various specific embodiments, those skilled in the art will recognize that the invention can be practiced with modification within the spirit and scope of the claims.

What is claimed is:

1. A method of repairing a nozzle segment for use in a locomotive engine, wherein the nozzle segment includes at least one airfoil extending between an inner band and an outer band, the airfoil includes a first sidewall and an opposing second sidewall that are joined together at a leading edge and at an axially-spaced trailing edge, said method comprises:
identifying a damaged portion of the airfoil;
repairing the damaged portion of the airfoil by at least one of welding weld filler in the area of the damaged portion of the airfoil at room temperature, and brazing preform in the area of the damaged portion of the airfoil; and
blending at least one of the weld filler and the preform to remove excess material to facilitate finishing an outer surface of the airfoil.

2. A method in accordance with claim 1 wherein said method further comprises cleaning the airfoil to remove surface oxidation.

3. A method in accordance with claim 1 wherein identifying the damaged portion of the airfoil further comprises identifying whether the damaged portion is at least one of a linear damaged portion and a non-linear damaged portion.

4. A method in accordance with claim 3 wherein identifying the linear damaged portion further comprises welding weld filler in the area of the linear damaged portion.

5. A method in accordance with claim 3 wherein identifying the non-linear missing material damaged further comprises brazing preform in the area of the non-linear missing material damaged portion.

6. A method in accordance with claim 1 wherein repairing a portion of the airfoil further comprises at least one of welding weld filler to the airfoil wherein weld filler and the airfoil are fabricated from a substantially similar material, and brazing a preform to the airfoil wherein preform and the airfoil are fabricated from a substantially similar material.

7. A method in accordance with claim 1 wherein repairing a portion of the airfoil by weld filler in the area of the damaged portion of the airfoil to repair the airfoil further comprises welding a nickel-based filler to the airfoil.

8. A method in accordance with claim 1 wherein repairing a portion of the airfoil by brazing the preform in the area of the damaged portion further comprises brazing a nickel-based preform to the airfoil.

9. A method in accordance with claim 1 wherein repairing a portion of the airfoil by brazing further comprises heating the airfoil to activate the preform.

10. A method in accordance with claim 1 further comprising applying an environmental protection coating to at least a portion of the airfoil.

11. A method in accordance with claim 10 wherein applying an environmental protection coating further comprises applying the coating across at least one of preform and weld filler.

12. A method in accordance with claim 1 wherein said method further comprises inspecting the final dimensions of the airfoil.

13. A method of repairing a turbine nozzle segment for use in a gas turbine engine, wherein the nozzle segment includes at least one airfoil extending between an inner band and an outer band, the airfoil includes a first sidewall and an opposing second sidewall that are joined together at a leading edge and at an axially-spaced trailing edge, said method comprises:
identifying a damaged portion of the airfoil;
repairing the damaged portion of the airfoil by at least one of welding weld filler in the area of the damaged portion of the airfoil to repair the airfoil at an elevated temperature, and brazing preform in the area of the damaged portion of the airfoil; and
blending at least one of weld filler and preform to remove excess material to facilitate finishing an outer surface of the airfoil.

14. A method in accordance with claim 13 wherein repairing a portion of the airfoil by welding weld filler in the area of the damaged portion further comprises welding weld filler in the area of the damaged portion of the airfoil by performing superalloy welding at elevated temperature (SWET) welding.

15. A method in accordance with claim 13 repairing a portion of the airfoil by brazing the preform in the area of the damaged portion further comprises heating the airfoil to activate the preform.

16. A method in accordance with claim 13 wherein identifying the damaged portion of the airfoil further comprises identifying whether the damaged portion is at least one of a linear damaged portion and a non-linear damaged portion.

17. A method in accordance with claim 16 wherein identifying the linear damaged portion further comprises welding weld filler in the area of the linear damaged portion.

18. A method in accordance with claim 16 wherein identifying the non-linear damaged portion further comprises brazing the preform to the airfoil.

19. A method in accordance with claim 13 wherein repairing a portion of the airfoil further comprises at least one of welding weld filler to the airfoil wherein weld filler and the airfoil are fabricated from a substantially similar material, and brazing a preform to the airfoil wherein preform and the airfoil are fabricated from a substantially similar material.

20. A turbine nozzle segment comprising:
at least one airfoil extending between an inner band and an outer band, the airfoil comprising:
a first sidewall and an opposing second sidewall that are joined together at a leading edge and at an axially-spaced trailing edge;
a damaged portion positioned along at least one of said leading edge, trailing edge, first sidewall, and second sidewall; and
at least one of a weld repair and a preform braze coupled to said at least one airfoil in the area of the damaged portion.
